(19) United States
(12) Patent Application Publication
(10) Pub. No.: US 2013/0271368 A1
(43) Pub. Date: Oct. 17, 2013

(54) INFORMATION PROCESSING DEVICE, INFORMATION PROCESSING METHOD AND COMPUTER PROGRAM

(71) Applicant: Takahiro Shiroshima, Tokyo (JP)

(72) Inventor: Takahiro Shiroshima, Tokyo (JP)

(73) Assignee: NEC CORPORATION, Tokyo (JP)

(21) Appl. No.: 13/995,541

(22) PCT Filed: Dec. 16, 2011
(86) PCT No.: PCT/JP2011/079961

§ 371 Date: Jun. 19, 2013

(30) Foreign Application Priority Data
Dec. 20, 2010 (JP) 2010-282958

(51) Int. Cl. G06F 3/01

(52) U.S. Cl. CPC G06F 3/011
USPC 345/156

(57) ABSTRACT

Provided is an information processing device capable of executing a larger variety of processes on screen data on the basis of motion of the device body.

An information processing device 1 has: a display unit 11 provided with a display screen; a contact detection unit 12 which detects contacting operation to the display screen and a position of the contact; a motion detection unit 13 which detects information representing a motion of the own device; an operation mode selection unit 14 which, while the contact position detected by the contact detection unit 12 is kept included in any one of one or more operation areas defined in the display screen, selects a predetermined operation mode related to the operation area; a display process discrimination unit 15 which discriminates the content of a display process designated with respect to screen data displayed on the display screen, on the basis of a combination of the operation mode and information representing a motion of the own device; and a display process control unit 16 which, if information representing a motion of the own device is detected by the motion detection unit 13 while the operation mode is kept selected, executes a display process discriminated by the display process discrimination unit 15 on screen data.

### TECHNICAL FIELD

The present invention relates to an information processing device which executes a process in accordance with motion of the own device body.

### BACKGROUND ART

In recent years, there has been known an information processing device which executes a process in accordance with motion of the own device body caused by a user's tilting or swinging it. Such an information processing device acquires a moving distance and a tilt angle of the own device body by being equipped with an acceleration sensor and a tilt sensor. Accordingly, on the basis of the acquired moving distance and tilt angle, the information processing device executes a predetermined process. By executing a process in accordance with a motion of the own device body, the information processing device provides the user with intuitive and natural operability.

For example, Patent Document 1 describes an electronic apparatus in which information displayed on the display screen is enlarged or reduced in accordance with a motion of the apparatus body. This electronic apparatus described in Patent Document 1 detects the amount of movement of a display unit provided in the apparatus body in the perpendicular direction to the display screen surface. Then, the electronic apparatus enlarges or reduces information on the display by a display magnification according to the detected movement amount.

Patent Document 2 describes a device in which the cursor position is changed in accordance with a tilt of the device. This device described in Patent Document 2 calculates the amount of cursor movement on the basis of a tilt and a moving speed of the device. Then, the device changes the cursor position by using the calculated amount of cursor movement.

Patent Document 3 describes a data communication system in which a delay time of data sent from a first device to a second device until it is displayed on the second device is changed on the basis of a tilt of the first device. In this data communication system described in Patent Document 3, the first device detects its own tilt at the time of its performing data sending operation. Then, the first device sends a certain delay time predetermined according to the tilt, along with the corresponding data, to the second device. The second device displays the received data on the screen after the elapse of the received delay time.

Patent Document 1: Japanese Patent Application Laid-Open No. 2008-77655

Patent Document 2: Japanese Patent Application Laid-Open No. 2000-250702

Patent Document 3: Japanese Patent Application Laid-Open No. 2010-217938

Patent Document 4: Japanese Patent Application Laid-Open No. 2008-148860

### SUMMARY OF INVENTION

### Technical Problem

A general information processing device can perform, on screen data displayed on its display unit, a variety of processes including the processes not only of such as enlargement or reduction, cursor movement and sending screen data but also of such as drawing a figure and switching or scrolling screen data.

However, in the electronic apparatus described in Patent Document 1, a process able to be performed on the basis of a moving direction and the amount of movement of the apparatus body is limited only to enlargement or reduction of screen data. In the device described in Patent Document 2, a process able to be performed on the basis of a tilt and a moving speed of the device is limited only to cursor movement. In the data communication system described in Patent Document 3, a process able to be performed on the basis of a tilt of the first device is limited only to changing of a delay time from data sending to data displaying at the receiving side.

As has been described above, although operation of moving a device body can provide intuitive and natural operability, it can enable acquisition of only limited types of operational amounts such as a tilt angle, a moving distance and a moving speed. Accordingly, the types of processes able to be performed in accordance with such operational amounts are limited. As a result, the electronic apparatus, device or data communication system described in Patent Documents 1 to 3 have a problem in that a variety of processes cannot be performed on screen data on the basis of motion of a device body.

The present invention has been made to solve the problem described above, and its primary objective is to provide an information processing device which can perform a larger variety of processes on screen data on the basis of motion of a device body.

### Solution to Problem

An information processing device of the present invention includes: a display unit provided with a display screen for displaying data; a contact detection unit which detects contacting operation to the display screen and a contact position of the operation; a motion detection unit which detects information representing a motion of its own device; an operation mode selection unit which, while the contact position detected by the contact detection unit is kept included in any one of one or more operation areas defined in advance within the area of the display screen, keeps selecting a predetermined operation mode related to the operation area; a display process discrimination unit which discriminates a content of a display process designated with respect to screen data displayed on the display screen, on the basis of a combination of the operation mode and the information representing a motion of the own device; and a display process control unit which executes, to the screen data, the display process discriminated by the display process discrimination unit if the information representing a motion of the own device is detected by the motion detection unit while the operation mode is kept selected by the operation mode selection unit.

An information processing method of the present invention includes: detecting contacting operation to display screen and a contact position of the operation; keeping selecting, while the contact position is kept included in any one of one or more operation areas defined in advance within the area of the display screen, a predetermined operation mode related to the operation area; detecting information representing a motion of the own device while the operation mode is kept selected; discriminating a content of a display process designated with respect to screen data displayed on the display screen, on the basis a combination of the operation mode and the information representing a motion of the own device; and executing discriminated the display process on the screen data.

Further, a computer program of the present invention causes an information processing device to execute: a process of detecting contacting operation to display screen and a contact position of the operation; a process of keeping selecting, while the contact position is kept included in any one of one or more operation area defined in advance within the area of the display screen, a predetermined operation mode related to the operation area; a process of detecting information representing a motion of the own device while the operation mode is kept selected; a process of discriminating a content of a display process designated with respect to screen data displayed on the display screen, on the basis a combination of the operation mode and the information representing a motion of the own device; and a process of executing discriminated the display process on the screen data.

### Advantageous Effect of Invention

The present invention can provide an information processing device which performs a larger variety of processes on screen data on the basis of motion of the device body.

### BRIEF DESCRIPTION OF THE DRAWINGS

FIG. 1 is a functional block diagram of an information processing device as a first exemplary embodiment of the present invention.

FIG. 2 is a diagram showing an example of a display screen of a display unit in the first exemplary embodiment of the present invention.

FIG. 3 is a diagram showing an example of correspondence relationships between operation areas and operation modes, in the first exemplary embodiment of the present invention.

FIG. 4 is a diagram showing an example of correspondence relationships among operation modes, motions of a device body and display processes, in the first exemplary embodiment of the present invention.

FIG. 5 is a flow chart illustrating operation of the information processing device as the first exemplary embodiment of the present invention.

FIG. 6 is a functional block diagram of an information processing device as a second exemplary embodiment of the present invention.

FIG. 7 is a diagram showing an example of correspondence relationships between operation areas and operation modes, in the second exemplary embodiment of the present invention.

FIG. 8 is a diagram showing an example of a display screen of a display unit in the second exemplary embodiment of the present invention.

FIG. 9 is a diagram showing an example of correspondence relationships among operation modes, motions of a device body and display processes, in the second exemplary embodiment of the present invention.

FIG. 10 is a diagram showing an example of starting process information in the second exemplary embodiment of the present invention.

FIG. 11 is a diagram showing an example of during-operation-mode process information in the second exemplary embodiment of the present invention.

FIG. 12 is a diagram showing an example of ending process information in the second exemplary embodiment of the present invention.

FIG. 13 is a flow chart illustrating operation of the information processing device as the second exemplary embodiment of the present invention.

FIG. 14 is a functional block diagram of an information processing device as a third exemplary embodiment of the present invention.

FIG. 15 is a diagram showing an example of starting process information in the third exemplary embodiment of the present invention.

FIG. 16 is a diagram showing an example of during-operation-mode process information in the third exemplary embodiment of the present invention.

FIG. 17 is a diagram showing an example of ending process information in the third exemplary embodiment of the present invention.

FIG. 18 is a flow chart illustrating operation of the information processing device as the third exemplary embodiment of the present invention.

FIG. 19 is a block configuration diagram illustrating an example of elements constituting a computer.

### DESCRIPTION OF EMBODIMENTS

Hereinafter, exemplary embodiments of the present invention will be described in detail with reference to drawings.

### First Exemplary Embodiment

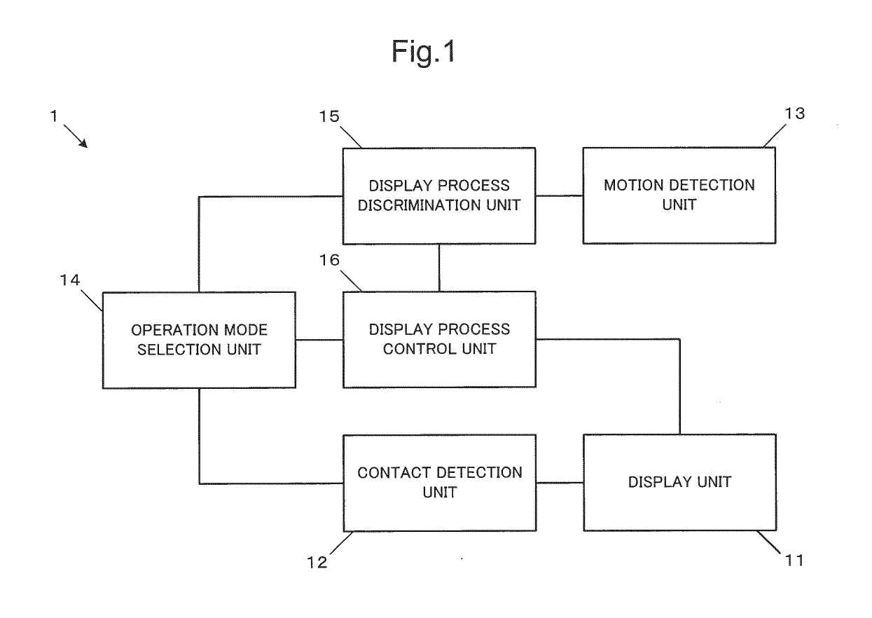

FIG. 1 shows a functional block configuration of an information processing device 1 as a first exemplary embodiment of the present invention. In FIG. 1, the information processing device 1 has a display unit 11, a contact detection unit 12, a motion detection unit 13, an operation mode selection unit 14, a display process discrimination unit 15 and a display process control unit 16.

Here, the information processing device 1 includes a CPU (Central Processing Unit), a RAM (Random Access Memory), a ROM (Read Only Memory), a storage device such as a hard disk, a liquid crystal display, a touch panel covering the liquid crystal display and a gyroscope. The information processing device 1 may be constituted by a device enabling the user's operation of tilting and moving the device body and the like, such as a cellular phone, a PDA (Personal Digital Assistant) and a smart phone.

The display unit 11 is constituted by a liquid crystal display. The contact detection unit 12 is constituted by a touch panel. The motion detection unit 13 is constituted by a gyroscope. The operation mode selection unit 14, the display process discrimination unit 15 and the display process control unit 16 are constituted by a CPU which reads out a computer program stored in a storage device or a ROM into a RAM and executes the computer program. Here, a hardware configuration constituting the functional blocks of the information processing device 1 is not limited to the configuration described above. For example, the operation mode selection unit 14, the display process discrimination unit 15 and the display process control unit 16 may be constituted by dedicated hardware.

The display unit 11 has a display screen for displaying data. Specifically, the display unit 11 displays screen data which is generated by processing of various kinds of data stored in the storage device of the information processing device 1 into data for display performed by an OS (Operating System) or various kinds of application software installed in the information processing device 1. For example, the display unit 11 may display screen data representing a still image or a video image processed by an image viewer application, on the display screen. The display unit 11 may display screen data representing the content of a document file processed by a document creation application, on the display screen. The display unit 11 may display screen data representing a file list processed by the OS, on the display screen. If the information processing device 1 is equipped with a network communication device, the display unit 11 may display screen data representing various kinds of data acquired from another information processing device via the network communication device, on the display screen.

In an area within the display screen of the display unit 11, one or more operation areas are defined in advance. For example, in these predetermined operation areas, the display unit 11 may display operational button images indicating that the areas are operation areas.

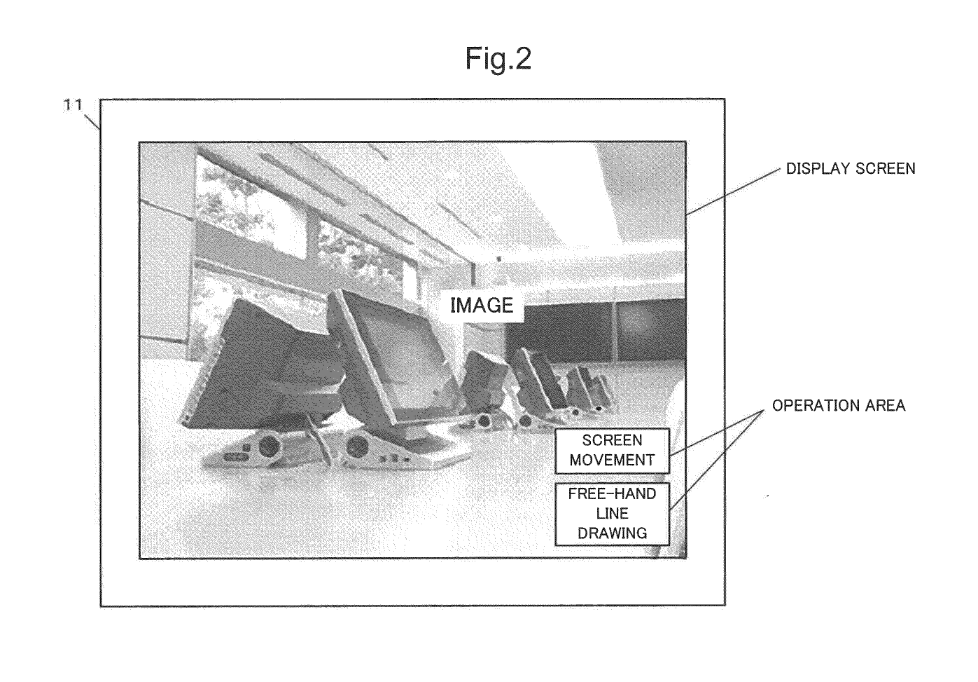

FIG. 2 shows an example of a display screen of the display unit 11. In FIG. 2, the display unit 11 is displaying the screen data representing a still image stored in the storage device. The screen data may be the one representing the whole area of a still image stored in the storage device. The screen data may be the one representing a partial area of a still image stored in the storage device. The display unit 11 is further displaying two operational button images of “screen movement” and “free-hand line drawing” indicating respective ones of corresponding two operation areas.

The contact detection unit 12 detects contacting operation to the display screen of the display unit 11 and the contact position. For example, the contact detection unit 12 detects the user's contacting the display screen of the display unit 11 with a finger or the like, and acquires a coordinate representing the position of the contact.

The motion detection unit 13 detects information representing a motion of the body of the information processing device 1. For example, the motion detection unit 13 may detect a tilt angle as information representing a tilt of the body of the information processing device 1. The motion detection unit 13 may also detect, as information representing a motion of the body of the information processing device 1, the moving direction and the moving distance of the motion.

While the contact position detected by the contact detection unit 12 is kept included in any one of the operation areas within the display screen of the display unit 11, the operation mode selection unit 14 selects a predetermined operation mode related to the operation area.

That is, while the user's finger or the like keeps contacting any one of the operation areas, the operation mode selection unit 14 keeps selecting a corresponding operation mode. Then, if the user's finger is removed from the operation area, the operation mode selection unit 14 stops selecting the operation mode.

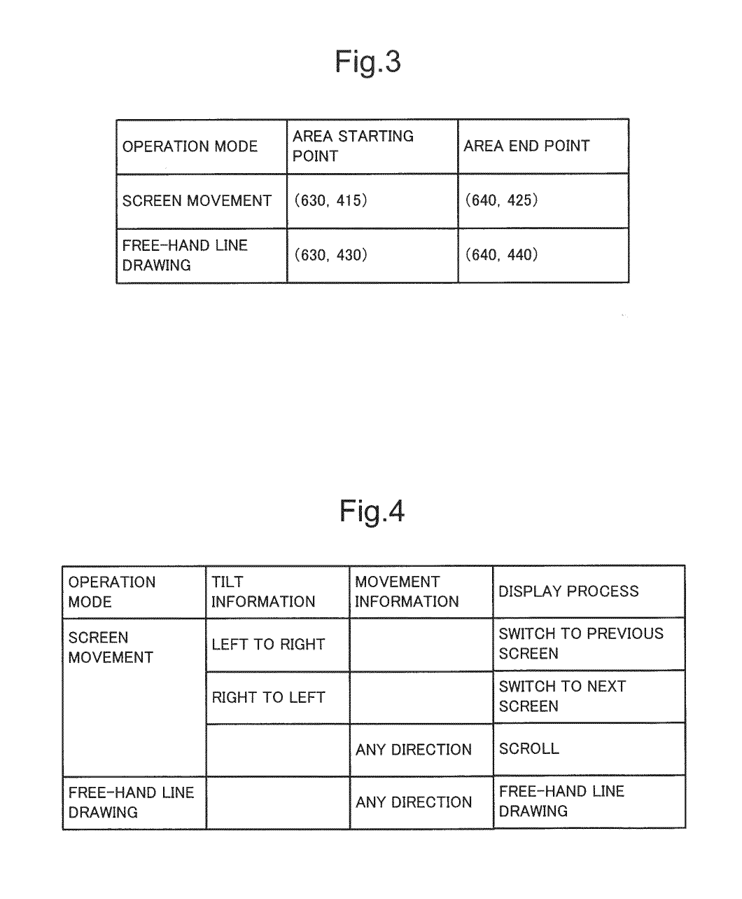

Specifically, in advance, the operation mode selection unit 14 stores correspondence relationships between operation areas and operation modes such as shown in FIG. 3. FIG. 3 indicates that, for example, the operation mode “screen movement” is related to a rectangular operation area containing two points with coordinates (630,415) and (640,425) as vertexes. Here, the operation mode “screen movement” represents a mode of executing movement of a screen such as switching or scrolling screen data in accordance with the user's operation. The operation mode “free-hand line drawing” represents a mode of drawing a free-hand line in a manner to superpose it on screen data in accordance with the user's operation. Here, operation modes are not limited to these two. Although FIG. 3 shows an example in which each operation area is represented as a rectangle specified by coordinates of two points, operation areas may be represented in another shape. For example, an operation area may be represented as a closed area surrounded by a line segment connecting a plurality of points. In this case, the selection unit 14 needs only to hold the coordinates of corresponding plurality of points as an operation area related to an operation mode.

The display process discrimination unit 15 discriminates the content of a display process designated with respect to screen data displayed on the display unit 11, on the basis of an operation mode and information representing a motion of the body of the information processing device 1 detected by the motion detection unit 13.

For example, the display process discrimination unit 15 may store in advance, as shown in FIG. 4, operation correspondence information which represents correspondence relationships each between a combination of an operation mode and information representing a motion of the body of the information processing device 1 and the content of a display process. FIG. 4 is an example of operation correspondence information in the case where tilt information representing a tilt and movement information representing a movement are used as information representing a motion of the body of the information processing device 1. Here, display processes may be those realized by a program executed by a CPU. Content of each display process may be identification information corresponding to a program for executing the process. Contents of display processes each may be information for discriminating a program for executing the process.

In the case of referring to the operation correspondence information of FIG. 4, if tilt information of “left to right” is detected while the operation mode is “screen movement”, the display process discrimination unit 15 discriminates the content of a display process designated by the user with respect to screen data to be “switch to the previous screen”. Here, “left to right” represents a pattern of tilt change in the left-right direction such as of when the user tilts the information processing device 1 to the left and subsequently to the right.

If tilt information of “right to left” is detected while the operation mode is “screen movement”, the display process discrimination unit 15 discriminates the content of a display process designated by the user with respect to screen data to be “switch to the next screen”. Here, “right to left” represents a pattern of tilt change in the left-right direction such as of when the user tilts the information processing device 1 to the right and subsequently to the left.

The display process discrimination unit 15 may discriminate a pattern of tilt change in the left-right direction on the basis of a tilt angle detected by the motion detection unit 13, using up-down and left-right directions defined in advance with respect to the display screen of the display unit 11.

If a movement of the information processing device 1 in any direction is detected while the operation mode is “screen movement”, the display process discrimination unit 15 discriminates the content of a display process designated by the user with respect to screen data to be “scroll”.

If a movement of the information processing device 1 in any direction is detected while the operation mode is “free-hand line drawing”, the display process discrimination unit 15 discriminates the content of a display process designated by the user with respect to screen data to be “free-hand line drawing”.

Here, operation correspondence information used for discriminating the content of a display process by the display process discrimination unit 15 is not limited to the example of FIG. 4. For example, to the combination of the operation mode “free-hand line drawing” and the tilt information “left to right”, a display process “closed curve drawing” may be related. Also, a display process “enlargement” may be related to a combination of an operation mode “enlargement/reduction” and movement information “upward direction”, and the content of a display process “reduction” may be related to a combination of an operation mode “enlargement/reduction” and movement information “downward direction”.

If information representing a motion of the body of the information processing device 1 is detected by the motion detection unit 13 while the operation mode selection unit 14 keeps selecting any one of the operation modes, the display process control unit 16 executes the display process of content discriminated by the display process discrimination unit 15.

That is, if the user performs operation of moving the body of the information processing device 1 while contacting any one of the operation areas with a finger or the like, the display process control unit 16 executes the display process of content based on an operation mode corresponding to the operation area being contacted and the motion of the body of the information processing device 1 on screen data displayed on the display unit 11.

For example, it is supposed that the display unit 11 is displaying screen data representing one of still images stored in the storage device with a number in a predetermined order given to each of them. In this situation, if the content of a display process determined by the display process discrimination unit 15 is “switch to the previous image”, the display process control unit 16 executes a display process of switching screen data to a still image which is given the order number prior by one to that of a currently displayed still image.

In the case a display process discriminated by the display process discrimination unit 15 is “scroll”, the display process control unit 16 determines the scroll direction to be any one of the upward, downward, left and right directions on the basis of a detected moving direction. If the screen data is the one able to be scrolled in any directions, the display process control unit 16 may take a detected moving direction itself as the scroll direction. The display process control unit 16 converts the detected moving distance into a display distance expressed in the unit of the coordinate on the display screen of the display unit 11 at a predetermined rate. Then, the display process control unit 16 executes a display process of scrolling the screen data by the amount of the converted display distance in the determined scroll direction.

In the case a process determined by the display process discrimination unit 15 is “free-hand line drawing”, the display process control unit 16 firstly holds a predetermined coordinate such as of the screen center of the display unit 11 as the current operation position. The display process control unit 16 sets a detected moving direction as the drawing direction. The display process control unit 16 converts a detected moving distance into a display distance expressed in the unit of the coordinate on the display screen of the display unit 11. Then, the display process control unit 16 executes a process of drawing a line of the length corresponding to the display distance from the current operation position in the drawing direction, and displays the line on the display unit 11. Additionally, the display process control unit 16 shifts the current operation position in the drawing direction by the amount of the display distance. Then, by repeating the process of drawing a line and shifting the current operation position at that time by the amount of a display distance in a drawing direction, the display process control unit 16 displays a free-hand line superposed on screen data of the display unit 11.

Here, the display process control unit 16 may cause application software or an OS processing screen data to execute a display process discriminated by the display process discrimination unit 15, by notifying them of the display process.

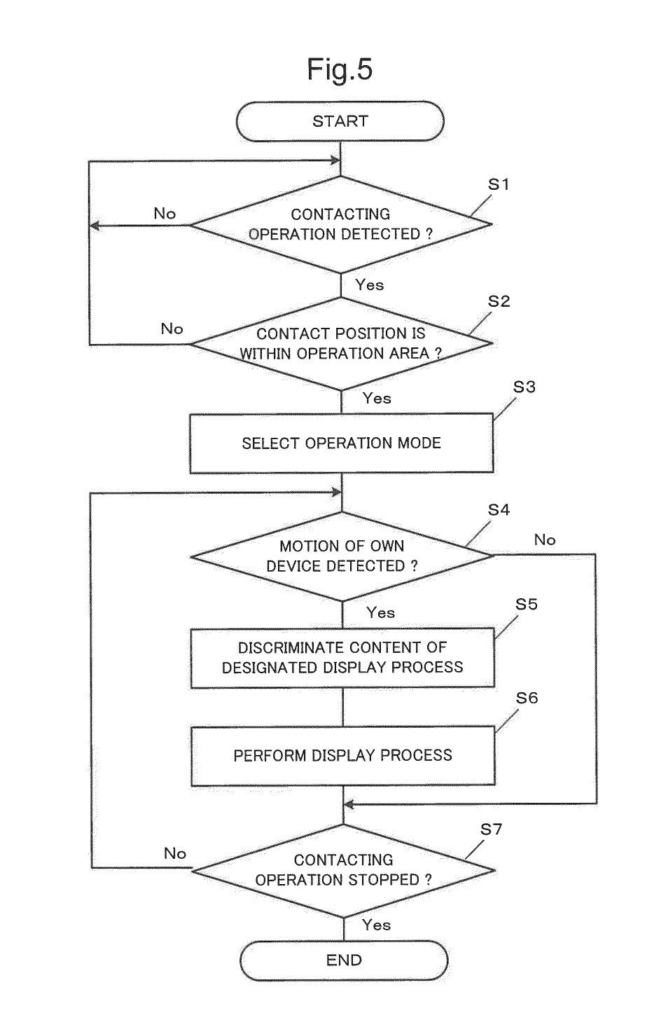

Description will be given below of operation of the information processing device 1 configured as above, with reference to FIG. 5. Here, it is supposed that the information processing device 1 starts the following operation in a state it is already displaying some screen data on the display unit 11.

First, the operation mode selection unit 14 determines whether or not contacting operation to the display screen of the display unit 11 has been detected by the contact detection unit 12 (step S1).

Here, if determining that no contacting operation has been detected, the operation mode selection unit 14 repeatedly executes the step S1.

On the other hand, if determining that any contacting operation is detected, the operation mode selection unit 14 determines whether or not a contact position detected by the contact detection unit 12 is included in any one of one or more operation areas stored in advance (step S2).

Here, if determining that the contact position is included in none of the operation areas, the operation mode selection unit 14 executes again the processing from the step S1.

On the other hand, if determining that the contact position is included in any one of the operation areas, the operation mode selection unit 14 selects the operation mode related in advance to the operation area including the contact position (step S3).

For example, in the case the contact position is included in the operation area related to the operation mode “screen movement”, the operation mode selection unit 14 selects the operation mode “screen movement”.

Next, the display process discrimination unit 15 determines whether or not information representing a motion of the body of the information processing device 1 has been detected by the motion detection unit 13 (step S4).

In this processing, the display process discrimination unit 15 may determine that information representing a motion has been detected if, for example, a tilt angle, a moving distance, a moving speed or the like detected by the motion detection unit 13 exceeds a threshold value.

If determining that no motion of the body of the information processing device 1 has been detected in the step S4, operation of the information processing device 1 proceeds to a step S7.

On the other hand, if determining that a motion of the body of the information processing device 1 has been detected in the step S4, the display process discrimination unit 15 discriminates the content of a designated display process on the basis of the currently selected operation mode and various kinds of information detected by the motion detection unit 13 (step S5).

In this processing, the display process discrimination unit 15 may discriminate the content of a display process on the basis of operation correspondence information such as shown in FIG. 4. For example, in the case the operation mode selected in the step S3 is “screen movement” and a motion of the body of the information processing device 1 in any direction has been detected, the display process discrimination unit 15 discriminates the content of a designated display process to be “scroll”.

Next, the display process control unit 16 displays screen data updated by executing the display process discriminated in the step S5 on the display unit 11 (step S6).

For example, in the case the content of the display process discriminated in the step S5 is “scroll”, the display process control unit 16 executes a display process of scrolling screen data on the basis of a moving direction and a moving distance detected in the step S4.

Next, the operation mode selection unit 14 determines whether or not the contacting operation has been stopped (step S7).

Here, if determining that the contacting operation has been stopped, the operation mode selection unit 14 stops selecting the operation mode, and the information processing device 1 ends the operation.

On the other hand, if determining that the contacting operation has not been stopped, the operation of the information processing device 1 returns to the step S4.

With that, description of the operation of the information processing device 1 will be finished.

In the first exemplary embodiment, description has been given of an example in which the display unit 11 displays operational button images representing operation areas. However, the display unit 11 does not necessarily need to display the operational button images representing operation areas. Even in such a case, it is only necessary that the operation mode selection unit 14 stores correspondence relationships between operation areas and predetermined operation modes such as shown in FIG. 3.

Next, the advantageous effect of the first exemplary embodiment of the present invention will be described.

The information processing device as the first exemplary embodiment of the present invention can perform a larger variety of processes on screen data on the basis of motion of the device body.

It is because: one or more operation areas are defined in advance within an area of the display screen, and, while contacting operation to any one of the operation areas is kept detected, the operation mode selection unit selects a predetermined operation mode related to the operation area; and, on the basis of the selected operation mode and motion of the device body, the display process discrimination unit discriminates the content of a display process with respect to screen data.

As a result, the information processing device as the first exemplary embodiment of the present invention can perform a variety of display processes in response to identical operation of moving the device body. Additionally, because it is easy for the user to perform the operation of moving the device body while touching an operation area defined on the display screen, the information processing device as the first exemplary embodiment of the present invention can maintain intuitive operability while providing a variety of display processes with respect to screen data.

### Second Exemplary Embodiment

Next, a second exemplary embodiment of the present invention will be described in detail with reference to drawings. Here, in each of the drawings referred to in the following description of the second exemplary embodiment of the present invention, to the same configuration as or a step of the same operation as that in the first exemplary embodiment of the present invention, the identical sign with that in the first exemplary embodiment is given, and its detailed description will be omitted in the second exemplary embodiment of the present invention.

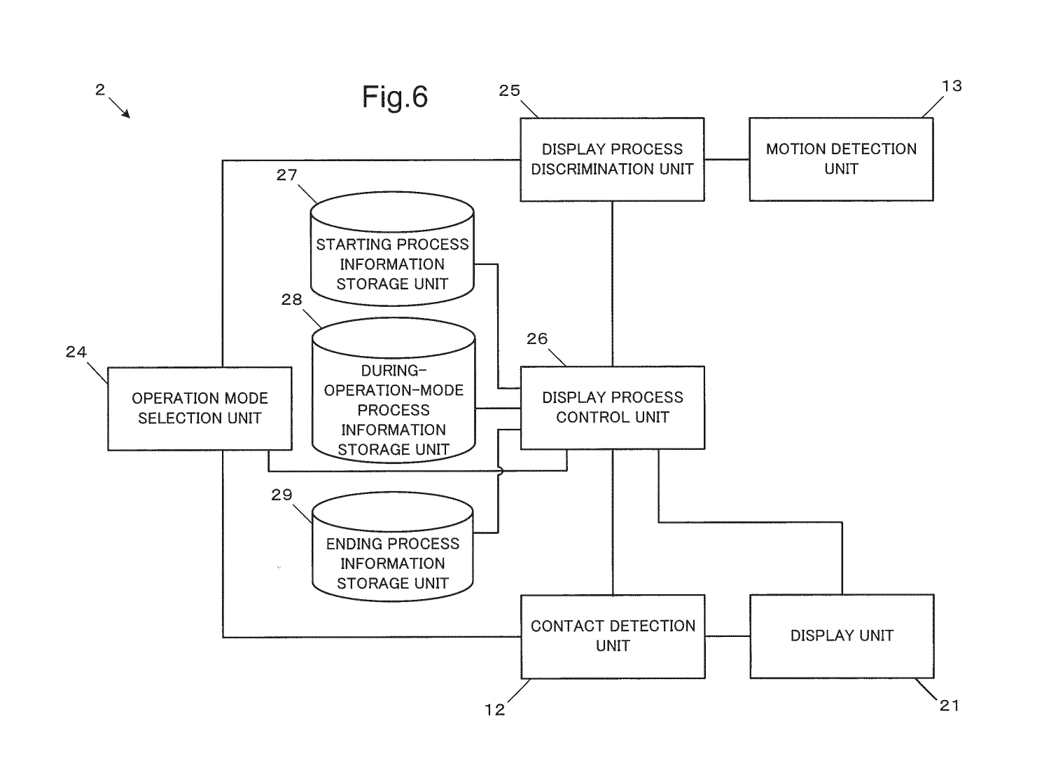

FIG. 6 shows an information processing device 2 as the second exemplary embodiment of the present invention. In FIG. 6, the information processing device 2 is different from the information processing device 1 as the first exemplary embodiment of the present invention in the following points. First, the information processing device 2 has a display unit 21 in place of the display unit 11, an operation mode selection unit 24 in place of the operation mode selection unit 14, a display process discrimination unit 25 in place of the display process discrimination unit 15, and a display process control unit 26 in place of the display process control unit 16. The information processing device 2 has a starting process information storage unit 27, a during-operation-mode process information storage unit 28 and an ending process information storage unit 29.

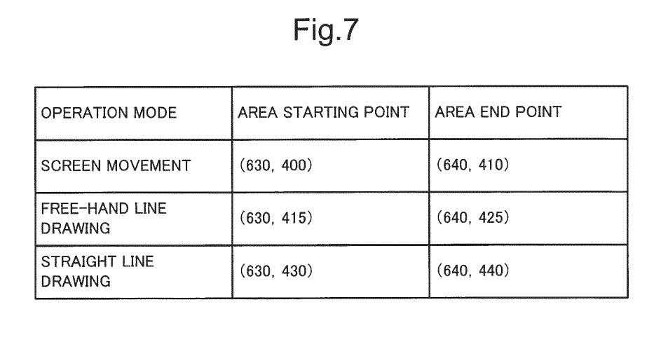

The operation mode selection unit 24 is configured similarly to the operation mode selection unit 14 in the first exemplary embodiment of the present invention. As shown in FIG. 7, the operation mode selection unit 24 stores in advance, in addition to the correspondence relationships between operation areas and operation modes shown in FIG. 3, a correspondence relationship between a third operation area and an operation mode “straight line drawing”.

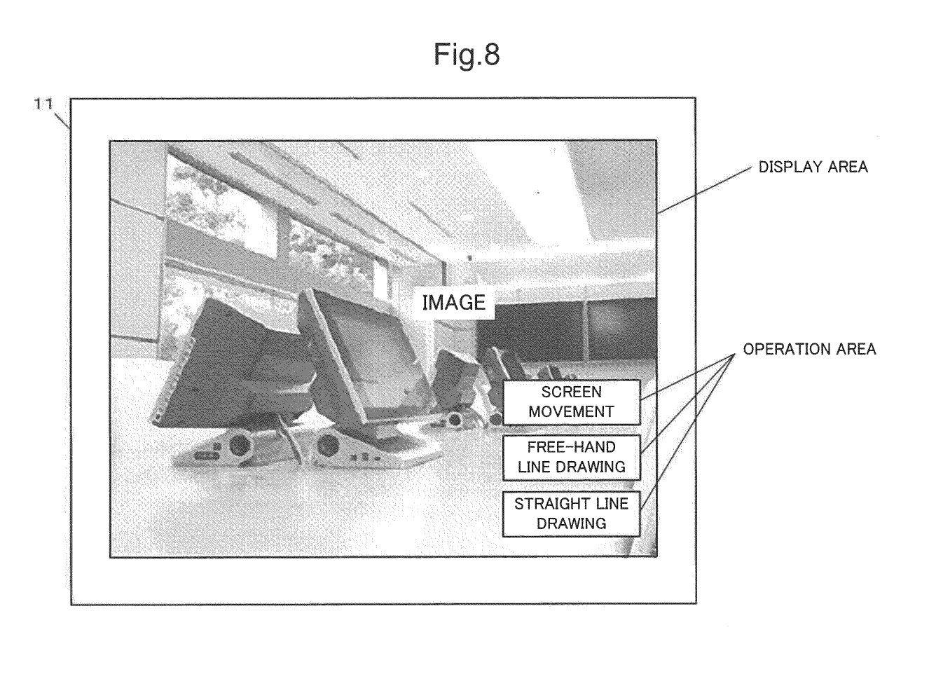

The display unit 21 is configured similarly to the display unit 11 in the first exemplary embodiment of the present invention. As shown in FIG. 8, the display unit 21 displays additionally an operational button image “straight line drawing” representing the third operation area described above. Here, similarly to the display unit 11 in the first exemplary embodiment of the present invention, the display unit 21 does not necessarily need to display operational button images representing operation areas.

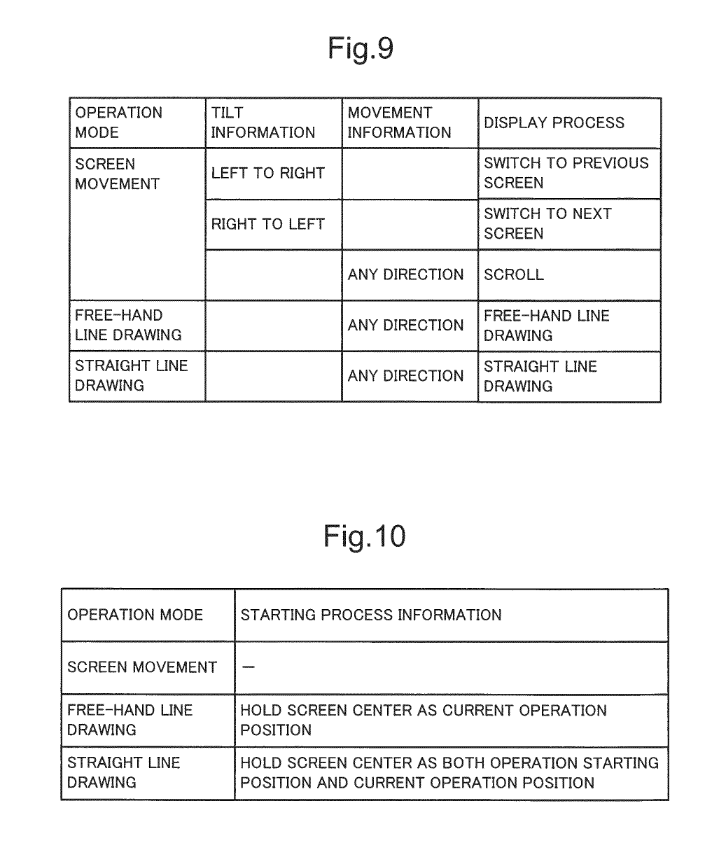

The display process discrimination unit 25 is configured similarly to the display process discrimination unit 15 in the first exemplary embodiment of the present invention. As shown in FIG. 9, the display process discrimination unit 25 stores, in addition to the operation correspondence information shown in FIG. 4, operation correspondence information which relates a combination of the operation mode “straight line drawing” and information representing a motion of the device body with the content of a display process.

By referring to the operation correspondence information shown in FIG. 8, if a movement of the information processing device 2 in any direction is detected while the operation mode is “straight line drawing”, the display process discrimination unit 25 discriminates the content of a display process designated with respect to screen data to be “straight line drawing”.

The display process discrimination unit 26 is configured similarly to the display process discrimination unit 16 in the first exemplary embodiment of the present invention.

The starting process information storage unit 27 stores operation modes and starting process information in a manner to relate them to each other. Here, the starting process information is information representing a starting process which is a process determined in advance to be executed at the time selection of an operation mode is started. The starting process information also includes the content of a preliminary process needed for executing a display process in the operation mode.

The starting process information may also be referred to as at-operation-mode-starting process information. The starting process information storage unit may also be referred to as an at-operation-mode-starting process information storage unit.

An example of the starting process information is shown in FIG. 10. In FIG. 10, starting process information related to the operation mode “free-hand line drawing” includes the content of a preliminary process which is “hold the screen center as the current operation position”. This preliminary process represents a process of setting an initial value of current operation position which becomes necessary in a display process for free-hand line drawing. Starting process information related to the operation mode “straight line drawing” includes the content of a preliminary process which is “hold the screen center as both the operation starting position and the current operation position”. This preliminary process represents a process of setting the starting point of a line which becomes necessary in a process for straight line drawing.

Such kinds of starting process information may be related in advance to operation modes requiring a preliminary process. Starting process information does not necessarily need to be related to an operation mode requiring no preliminary process. For example, in FIG. 10, no starting process information is related to the operation mode “screen movement”, regarding it as a mode requiring no preliminary process.

Here, the starting process information does not need to be limited to the example in FIG. 10, and may include the content of other kinds of preliminary processes or a combination of pieces of the content necessary for each operation mode.

The during-operation-mode process information storage unit 28 stores operation modes and during-operation-mode process information in a manner to relate them to each other. Here, the during-operation-mode process information is information representing a process determined in advance to be executed every time a display process is discriminated by the display process discrimination unit 25 while the corresponding operation mode is kept selected. The during-operation-mode process information includes process content constituting a display process discriminated by the display process discrimination unit 25.

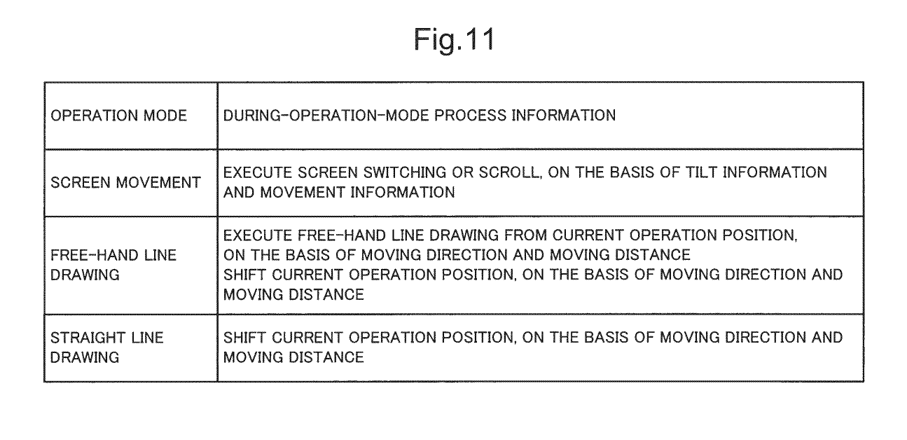

An example of this during-operation-mode process information is shown in FIG. 11. In FIG. 11, during-operation-mode process information related to the operation mode “screen movement” includes process content constituting a display process of “execute screen switching or screen scroll on the basis of tilt information and movement information”. During-operation-mode process information related to the operation mode “free-hand line drawing” includes process content of “draw a free-hand line from the current operation position on the basis of the moving direction and the moving distance” and process content of “shift the current operation position on the basis of the moving direction and the moving distance”. During-operation-mode process information related to the operation mode “straight line drawing” includes process content of “shift the current operation position on the basis of the moving direction and the moving distance”.

Here, the during-operation-mode process information related to the operation mode “straight line drawing” includes only the process content of shifting the current operation position and does not include process content of drawing a straight line. It is because, if a process of drawing a straight line is repeatedly executed on the basis of a moving direction and a moving distance every time the content of the display process is discriminated in the operation mode of “straight line drawing”, it becomes difficult to differentiate the process from that for free-hand line drawing.

Here, the during-operation-mode process information does not need to be limited to the example in FIG. 11, and may include other kinds of process content suitable to be executed during each operation mode or a combination of pieces of the content.

The ending process information storage unit 29 stores operation modes and ending process information in a manner to relate them to each other. Here, the ending process information is information representing an ending process which is a process determined in advance to be executed when selection of the operation mode is stopped. The ending process information includes process content constituting a display process discriminated by the display process discrimination unit 25.

The ending process information may also be referred to as at-operation-mode-ending process information. The ending process information storage unit may also be referred to as an at-operation-mode-ending process information storage unit.

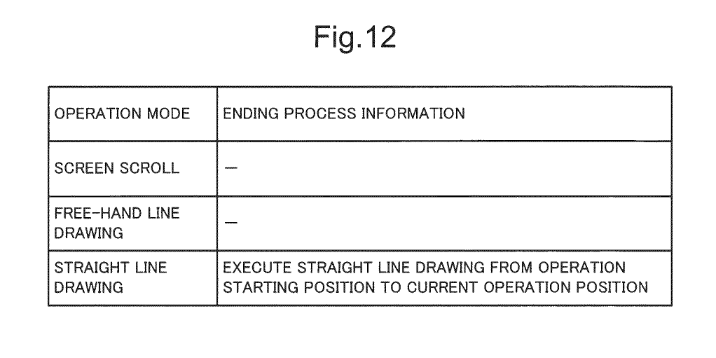

An example of this ending process information is shown in FIG. 12. In FIG. 12, ending process information related to the operation mode “straight line drawing” includes process content of “execute straight line drawing on the basis of the operation starting position and the current operation position”. According to the example of ending process information in FIG. 12, in the operation mode “straight line drawing”, a straight line is drawn at the time the selection of operation mode is stopped, that is, at the time the user has removed a finger from the corresponding operation area after moving the device body while touching the operation area. In the example in FIG. 12, no ending process information is related to the operation modes “screen movement” and “free-hand line drawing”. In this way, ending process information does not necessarily need to be related to an operation mode requiring no process to be executed at the time selection of the operation mode has been stopped.

Here, the ending process information does not need to be limited to the example in FIG. 12, and may include other kinds of process content suitable to be executed at the time of ending each operation mode or content representing a combination of pieces of the content.

When the operation mode selection unit 24 has started selecting an operation mode, the display process control unit 26 executes a process represented by starting process information related to the selected operation mode. Accordingly, the display process control unit 26 executes a preliminary process necessary for executing a display process in the selected operation mode.

While the operation mode selection unit 24 keeps selecting an operation mode, the display process control unit 26 executes a process represented by during-operation-mode process information related to the selected operation mode every time the display process discrimination unit 25 discriminates the content of a display process. Accordingly, the display process control unit 26 executes a process constituting a display process discriminated by the display process discrimination unit 25.

When the operation mode selection unit 24 has stopped selecting any one of the operation modes, the display process control unit 26 executes a process represented by ending process information related in advance to the operation mode. Accordingly, the display process control unit 26 completes the display process discriminated by the display process discrimination unit 25.

For example, when the operation mode selection unit 24 has started keeping the operation mode “straight line drawing” selected, the display process control unit 26 holds a predetermined coordinate such as of the screen center of the display unit 21 as both the operation starting position and the current operation position, as the starting process. Then, every time the content of a display process is discriminated during the operation mode, the display process control unit 26 executes the process of “shift the current operation position on the basis of the moving distance and the moving direction”, as a process constituting the discriminated display process “straight line drawing”. That is, the display process control unit 26 converts the detected moving distance into a display distance in the unit of the coordinate on the display screen of the display unit 21. Then, the display process control unit 26 shifts the current operation position by the amount of the display distance in the detected moving direction. At the time of ending the operation mode “straight line drawing”, the display process control unit 26 executes the process of “execute straight line drawing on the basis of the operation starting position and the current operation position”.

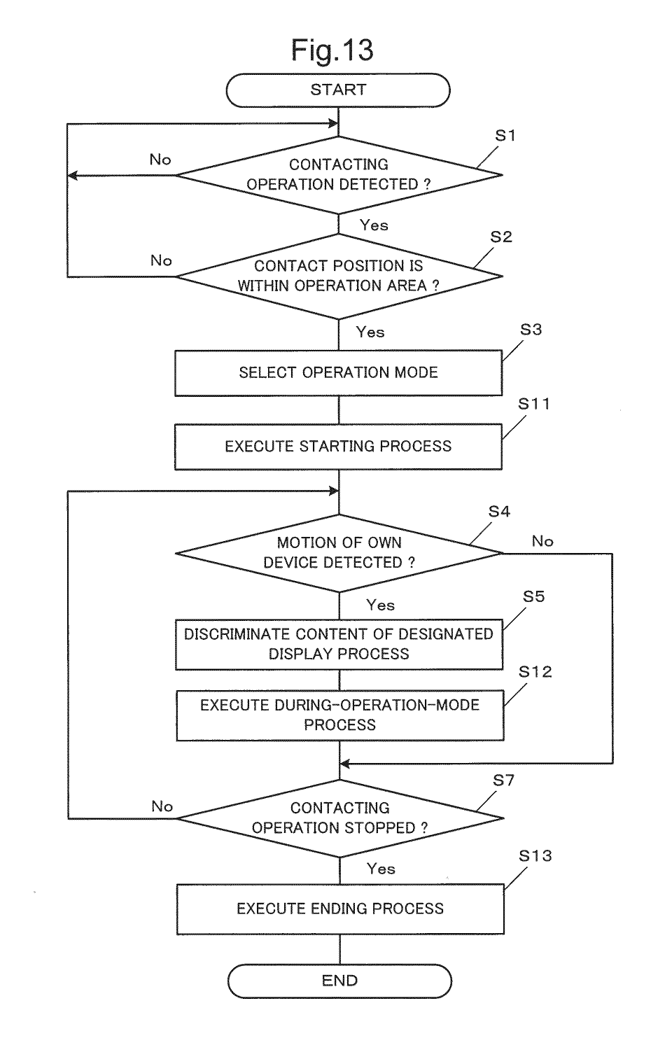

Operation of the information processing device 2 configured as above will be described with reference to FIG. 13. Here, it is supposed that the information processing device 2 starts the following operation in a state it is already displaying some screen data on the display unit 21.

First, by executing the steps from S1 to S3 similarly to the operation of the information processing device 1 as the first exemplary embodiment of the present invention, the information processing device 2 selects any one of the operation modes.

Next, the display process control unit 26 executes a process represented by starting process information related in advance to the selected operation mode (step S11).

For example, supposed is a case where starting process information shown in FIG. 10 is stored in the starting process information storage unit 27. In this case, if the operation mode selected in the step S3 is “screen movement”, because there is no starting process information related to the operation mode, the display process control units 26 executes no starting process. If the operation mode selected in the step S3 is “free-hand line drawing”, the display process control unit 26 holds the coordinate of the screen center as the current operation position, according to the starting process information related to the operation mode. If the operation mode selected in the step S3 is “straight line drawing”, the display process control unit 26 holds the coordinate of the screen center as both the operation starting position and the current operation position, according to the starting process information related to the operation mode.

Next, by executing the steps from S4 to S5 similarly to the operation of the information processing device 1 as the first exemplary embodiment of the present invention, the information processing device 2 discriminates the content of a display process depending on the operation mode and a motion of the device body.

Next, the display process control unit 26 executes a process represented by during-operation-mode process information related in advance to the selected operation mode (step S12).

For example, supposed is a case where during-operation-mode process information shown in FIG. 11 is stored in the during-operation-mode process information storage unit 28. In this case, if the operation mode selected in the step S3 is “screen movement”, the display process control unit 26 executes a display process (screen scroll or screen switching) discriminated by the display process discrimination unit 25 on the basis of tilt information and movement information, according to the during-operation-mode process information related to the operation mode. If the operation mode selected in the step S3 is “free-hand line drawing”, the display process control unit 26 executes free-hand line drawing from the current operation position and shifts the current operation position on the basis of a moving direction and a moving distance, according to the during-operation-mode process information related to the operation mode. If the operation mode selected in the step S3 is “straight line drawing”, the display process control unit 26 shifts the current operation position on the basis of a moving direction and a moving distance, according to the during-operation-mode process information related to the operation mode.

Next, when the operation mode selection unit 24 determines that the contacting operation has been stopped (Yes at the step S7), the display process control unit 26 executes a process represented by ending process information related in advance to the operation mode having been kept selected (step S13).

For example, supposed is a case where ending process information shown in FIG. 12 is stored in the ending process information storage unit 29. In this case, if the operation mode having been kept selected is “screen movement”, because there is no ending process information related to the operation mode, the display process control units 26 executes no ending process. Also if the operation mode having been kept selected is “free-hand line drawing”, because there is no ending process information related to the operation mode, the display process control units 26 executes no ending process. If the operation mode having been kept selected is “straight line drawing”, the display process control unit 26 executes straight line drawing from the operation starting position to the current operation position, according to the ending process information related to the operation mode.

With that, the information processing device 2 finishes the operation.

Next, the advantageous effect of the second exemplary embodiment of the present invention will be described.

The information processing device as the second exemplary embodiment of the present invention can execute a variety of display processes on the basis of motion of the device body with more appropriate timing.

It is because: starting process information, during-operation-mode process information and ending process information related to the operation modes are stored in advance; the display process control unit executes a process represented by the starting process information when operation mode selection is started; the display process control unit executes a process represented by the during-operation-mode process information when a display process is discriminated while an operation mode is kept selected; and the display process control unit executes a process represented by the ending process information when operation mode selection is stopped. That is, it is because the information processing device as the second exemplary embodiment of the present invention can differentiate the timing of executing processes constituting a display process among the operation modes.

As a result of it, the information processing devices as the second exemplary embodiment of the present invention can further increase the types of display processes able to be executed on the basis of motion of the device body. That is, the information processing device as the second exemplary embodiment of the present invention enables different setting for each operation mode so as to execute each display process with more appropriate timing on the basis of motion of the device body. It is because, by that way, it becomes possible to adopt a larger variety of display processes based on motion of the device body in the information processing device as the second exemplary embodiment of the present invention. For example, it becomes possible to adopt a display process such as of straight line drawing whose display processing result is difficult to be differentiated from that of free-hand line drawing if the both kinds of drawing are executed with the same timing.

### Third Exemplary Embodiment

Next, a third exemplary embodiment of the present invention will be described in detail with reference to drawings. Here, in each of the drawings referred to in the following description of the third exemplary embodiment of the present invention, to the same configuration as or a step of the same operation as that in the second exemplary embodiment of the present invention, the identical sign with that in the second exemplary embodiment is given, and its detailed description will be omitted in the third exemplary embodiment of the present invention.

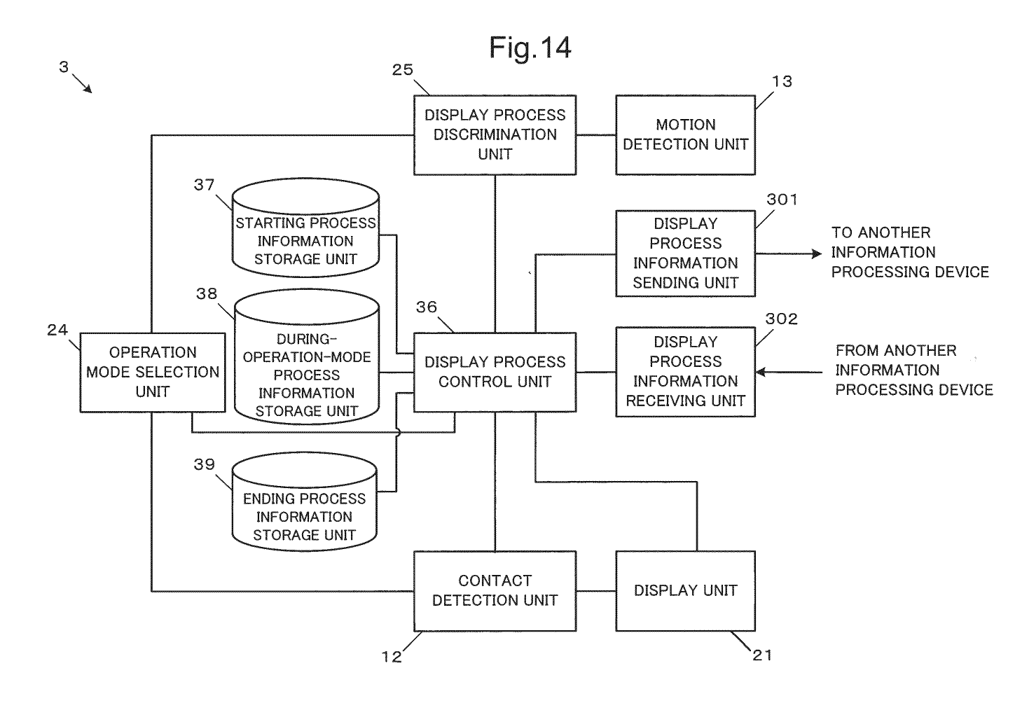

FIG. 14 shows an information processing device 3 as the third exemplary embodiment of the present invention. In FIG. 14, the information processing device 3 is different from the information processing device 2 as the second exemplary embodiment of the present invention in the following points. First, the information processing device 3 has a starting process information storage unit 37 in place of the starting process information storage unit 27, a during-operation-mode process information storage unit 38 in place of the during-operation-mode process information storage unit 28, an ending process information storage unit 39 in place of the ending process information storage unit 29, and a display process control unit 36 in place of the display process control unit 26. Further, the information processing device 3 has a display process information sending unit 301 and a display process information receiving unit 302.

Here, the information processing device 3 further comprises a wireless communication module in addition to the same hardware configuration as that of the information processing device 2 as the second exemplary embodiment of the present invention. The display process information sending unit 301 and the display process information receiving unit 302 are constituted by a CPU which reads out a computer program stored in a storage device or a ROM into a RAM and executes the program and by the wireless communication module. Here, hardware configurations constituting respective functional blocks of the information processing device 3 are not limited to the configurations described above. For example, the display process information sending unit 301 and the display process information receiving unit 302 may be constituted by dedicated hardware.

Further, the information processing device 3 is connected via the wireless communication module to another information processing device 3 which displays approximately the same screen data as that displayed on the display unit 21. For example, the information processing device 3 and the another information processing device 3 may be connected to an identical server on a network such as the internet connected via the wireless communication module, and may thus synchronously view identical screen data downloaded from the server. Further, the information processing device 3 and the another information processing device 3 are connected to be able to communicate with each other via, for example, a wireless communication network.

The starting process information storage unit 37 stores the content of a sending process which represents sending of a preliminary process included in starting process information to another information processing device 3, in a manner to further include the content into the starting process information.

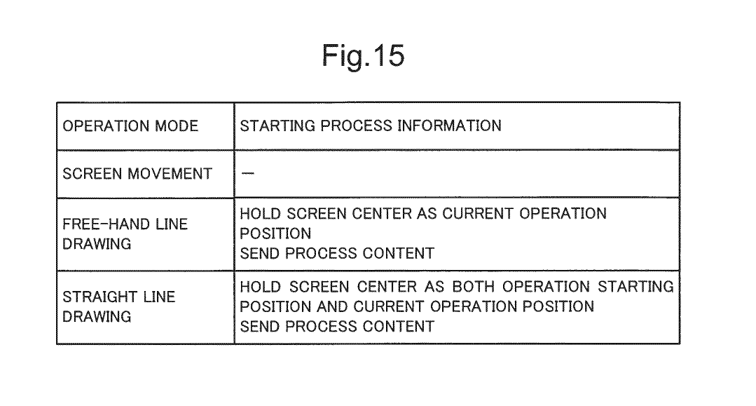

FIG. 15 shows an example of starting process information. In FIG. 15, starting process information related to the operation mode “free-hand line drawing” and that related to the mode “straight line drawing” each include, in addition to the content of the same preliminary process as that included in the starting process information in the second exemplary embodiment of the present invention, the content of a sending process which sends the content of the preliminary process to another information processing device 3.

The during-operation-mode process information storage unit 38 stores the content of a sending process which sends the process content included in during-operation-mode process information to another information processing device 3, in a manner to further include the content of a sending process into the during-operation-mode process information.

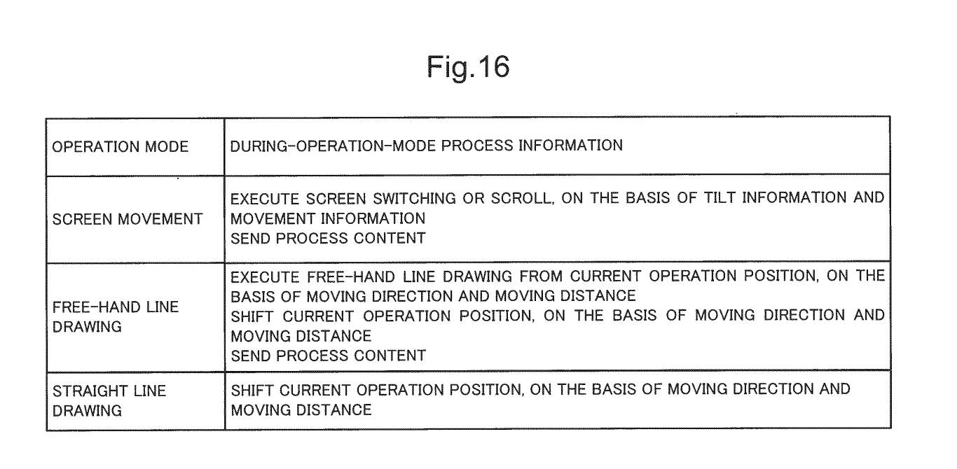

FIG. 16 shows an example of during-operation-mode process information. In FIG. 16, during-operation-mode process information related to the operation mode “screen movement” and that related to the mode “free-hand line drawing” each include, in addition to the same process content as that included in the during-operation-mode process information in the second exemplary embodiment of the present invention, the content of a sending process of sending the process content to another information processing device 3.

The ending process information storage unit 39 stores the content of a sending process which sends the process content included in ending process information to another information processing device 3, in a manner to further include the content of a sending process into the ending process information.

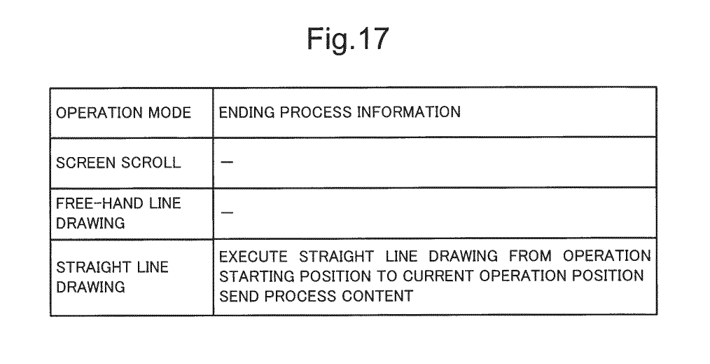

FIG. 17 shows an example of ending process information. In FIG. 17, ending process information related to the operation mode “straight line drawing” includes, in addition to the same process content as that included in the ending process information in the second exemplary embodiment of the present invention, the content of a sending process of sending the process content to another information processing device 3.

The display process control unit 36 is configured similarly to the display process control unit 26 in the second exemplary embodiment of the present invention. Further, the display process control unit 36 executes a process represented by display process information received by the display process information receiving unit 302 described later on screen data displayed on the display unit 21.

The display process information sending unit 301 sends display process information representing the content to be processed by the display process control unit 36 to another information processing device 3.

Here, the display process information may be information representing the aforementioned preliminary processes included in starting process information. The display process information may also be information representing process content included in during-operation-mode process information. The display process information may be information representing process content included in ending process information.

When the operation mode selection unit 24 has started keeping an operation mode selected, if the content of sending process is included in starting process information related to the selected operation mode, the display process information sending unit 301 sends display process information to another information processing device 3.

Every time the display process discrimination unit 25 discriminates a display process while the operation mode selection unit 24 keeps selecting an operation mode, if the content of sending process is included in during-operation-mode process information related to the currently selected operation mode, the display process information sending unit 301 sends display process information to another information processing device 3.

When the operation mode selection unit 24 has stopped keeping an operation mode selected, if the content of sending process is included in the ending process information related to the operation mode having been selected, the display process information sending unit 301 sends display process information to another information processing device 3.

The display process information receiving unit 302 receives display process information from another information processing device 3.

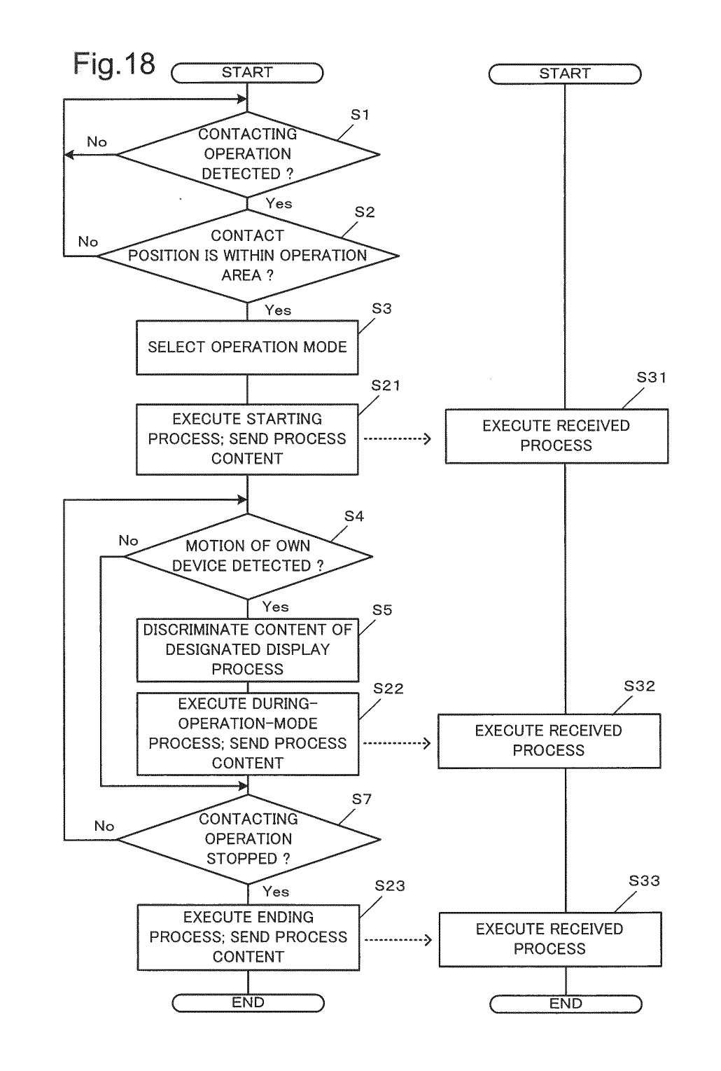

Operation of the information processing device 3 configured as above will be described with reference to FIG. 18. Here, in FIG. 18, it is supposed that the information processing device 3 starts the operation in a state it is displaying some screen data on the display unit 21 and is connected to another information processing device 3 which displays approximately the same screen data in a manner to enable the devices to communicate with each other. It is also supposed that, in FIG. 18, the left chart illustrates operation of the information processing device 3 and the right chart does operation of another information processing device 3.

In FIG. 18, although the information processing device 3 operates similarly to the information processing device 2 as the second exemplary embodiment of the present invention, the former is different from the latter in that it executes steps S21, S22 and S23 in place of the steps S11, S12 and S13.

In the step S21, if the content of a sending process representing sending of a preliminary process is included in starting process information related to an operation mode selected in the step S3, the display process information sending unit 301 sends the content of the preliminary process to another information processing device 3 as display process information.

Then, the display process information receiving unit 302 of the another information processing device 3 receives the content of the preliminary process as display process information. Then, the display process control unit 36 of the another information processing device 3 executes the received preliminary process on screen data (step S31).

For example, in the case the operation mode selected in the step S3 is “straight line drawing”, in the step S21, the display process control unit 36 executes the preliminary process “hold the coordinate of the screen center as both the operation starting position and the current operation position”. Then, the display process information sending unit 301 sends the content of this preliminary process to another information processing device 3. Then, in the step S31, the display process information receiving unit 302 of the another information processing device 3 receives the content of the preliminary process. Then, the display process control unit 36 of the another information processing device 3 executes the preliminary process “hold the coordinate of the screen center as both the operation starting position and the current operation position”.

In the step S22, if the content of sending display process information is included in during-operation-mode process information related to the operation mode selected in the step S3, the display process information sending unit 301 sends the display process information to the another information processing device 3.

Then, the display process information receiving unit 302 of the another information processing device 3 receives the display process information. Then, the display process control unit 36 of the another information processing device 3 executes a process represented by the received display process information on screen data (step S32).

For example, in the case the operation mode selected in the step S3 is “straight line drawing”, in the step S22, the display process control unit 36 executes the process “shift the current operation position on the basis of the moving direction and the moving distance” which constitutes the display process. Because no content of sending display process information is included in the during-operation-mode process information related to the operation mode “straight line drawing”, the display process information sending unit 301 sends no display process information to the another information processing device 3.

In the step S23, if the content of sending display process information is included in ending process information related to the operation mode selected in the step S3, the display process information sending unit 301 sends the display process information to the another information processing device 3.

Then, the display process information receiving unit 302 of the another information processing device 3 receives the display process information. Then, the display process control unit 36 of the another information processing device 3 executes a process represented by the received display process information on screen data (step S33).

For example, in the case the operation mode selected in the step S3 is “straight line drawing”, the display process control unit 36 executes the process “execute straight line drawing using the operation starting position and the current operation position” which constitutes the display process. Then, the display process information sending unit 301 sends display process information representing process content to be executed by the display process control unit 36 to the another information processing device 3. At that time, the display process information sending unit 301 may send also information representing the current operation position by including it into the display process information. Then, in the step S33, the display process information receiving unit 302 of the another information processing device 3 receives the display process information representing the process content. Then, on the basis of the received display process information, the display process control unit 36 of the another information processing device 3 executes the process “execute straight line drawing using the operation starting position and the current operation position”. That is, the display process control unit 36 of the another information processing device 3 executes the process of drawing a straight line using the operation starting position held by executing the preliminary process received in the step S31 and the current operation position included in the display process information received in the step S33.

With that, description of the operation of the information processing device 3 will be finished.

Next, the effect of the third exemplary embodiment of the present invention will be described.

The information processing device as the third exemplary embodiment of the present invention can synchronize screen data between own information processing device and another information processing device which displays approximately the same screen data as that of own information processing device, applying a larger variety of processes on screen data of the both devices on the basis of motion of one of the device bodies.

It is because the display process information sending unit sends display process information representing the content of a process to be executed by the display process control unit to another information processing device, the display process information receiving unit receives the display process information from another information processing device, and the display process control unit executes the received display process information on screen data.

Further, the information processing device as the third exemplary embodiment of the present invention can send display process information to another information processing device with appropriate timing for each operation mode, by including the content of a sending process representing the sending of display process information to another information processing device into starting process information, during-operation-mode process information or ending process information. As a result, the information processing device as the third exemplary embodiment of the present invention can synchronize screen data between the both devices with more appropriate timing on the basis of motion of one of the device bodies.

In each of the above-described exemplary embodiments of the present invention, the configuration may also be such that the operation of the information processing device described with reference to the corresponding flow chart is stored as a computer program of the present invention in a storage device (recording medium) of the information processing device, and the computer program is read out and executed by a CPU of the information processing device. Then, in such a case, the present invention is constituted by the code of the computer program or the recording medium.

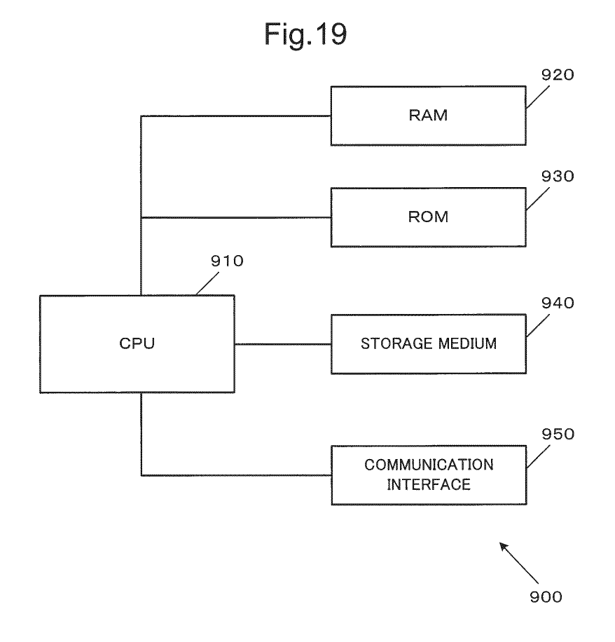

FIG. 19 is a block configuration diagram illustrating an example of elements constituting a computer. A computer 900 in FIG. 19 comprises a CPU 910, a RAM 920, a ROM 930, a storage medium 940 and a communication interface 950. The storage medium 940 may be an optical disk medium, a magnetic disk medium or a hard disk device. The components of the information processing devices 1, 2 and 3 described above may be realized by executing a program in the CPU 910 of the computer 900. Specifically, the operation mode selection units 14 and 24, the display process discrimination units 15 and 25, the display process control units 16, 26 and 36, the display process information sending unit 301 and the display process information receiving unit 302, which are components described in FIGS. 1, 6 and 14 described above, may be realized by the CPU 910 reading out a program from the ROM 930 or the storage medium 940 and executing the program. Then, in such a case, the present invention is constituted by the code of the computer program, or a storage device or a recording medium (for example, the storage medium 940, an attachable/detachable memory card not illustrated in the drawing and the like) storing the code of the computer program.

Further, the above-described exemplary embodiments can be implemented in a manner to combine them appropriately.

While the invention has been particularly shown and described with reference to preferred exemplary embodiments thereof, the invention is not limited to these embodiments. It is obvious that various changes in form and details may be made therein without departing from the spirit and scope of the present invention as defined by the claims.

This application is based upon and claims the benefit of priority from Japanese patent application No. 2010-282958, filed on Dec. 20, 2010, the disclosure of which is incorporated herein in its entirety by reference.

The whole or part of the exemplary embodiments disclosed above can be described as, but not limited to, the following supplementary notes.

(Supplementary Note 1)

An information processing device comprising:

a display unit provided with a display screen for displaying data;

a contact detection unit which detects contacting operation to the display screen and a contact position of the operation;

a motion detection unit which detects information representing a motion of its own device;

an operation mode selection unit which, while the contact position detected by the contact detection unit is kept included in any one of one or more operation areas defined in advance within the area of the display screen, keeps selecting a predetermined operation mode related to the operation area;

a display process discrimination unit which discriminates a content of a display process designated with respect to screen data displayed on the display screen, on the basis of a combination of the operation mode and the information representing a motion of the own device; and

a display process control unit which executes, to the screen data, the display process discriminated by the display process discrimination unit if the information representing a motion of the own device is detected by the motion detection unit while the operation mode is kept selected by the operation mode selection unit.

(Supplementary Note 2)

The information processing device described in supplementary note 1, wherein:

the information processing device is connected to another information processing device displaying approximately the same screen data as the screen data, and further comprising:

a display process information sending unit which sends display process information representing the content of a display process executed by the display process control unit to the another information processing device, and

a display process information receiving unit which receives the display process information from the another information processing devices; and

the display process control unit further executes, to the screen data, a process represented by the display process information received by the display process information receiving unit.

(Supplementary Note 3)

The information processing device described in supplementary notes 1 or 2 further comprising

a starting process information storage unit which stores the operation mode and starting process information representing a process determined in advance to be executed when selection of the operation mode is started, in a manner to relate them to each other, wherein:

the starting process information storage unit stores a content of a preliminary process necessary for executing the display process, by including the content into the starting process information; and

when the operation mode selection unit has started keeping the operation mode selected, the display process control unit executes a process represented by the starting process information related to the selected operation mode.

(Supplementary Note 4)

The information processing device described in any one of supplementary notes 1 to 3 further comprising:

a during-operation-mode process information storage unit which stores the operation mode and during-operation-mode process information representing a process determined in advance to be executed every time the display process is discriminated by the display process discrimination unit while the operation mode is kept selected, in a manner to relate them to each other, wherein:

the during-operation-mode process information storage unit stores process content constituting the display process, by including the process content into the during-operation-mode process information; and

every time the display process is discriminated by the display process discrimination unit while the operation mode is kept selected by the operation mode selection unit, the display process control unit executes a process represented by the during-operation-mode process information related to the selected operation mode.

(Supplementary Note 5)

The information processing device described in any one of supplementary notes 1 to 4 further comprising

an ending process information storage unit which stores the operation mode and ending process information representing a process determined in advance to be executed when selection of the operation mode has been stopped, in a manner to relate them to each other, wherein:

the ending process information storage unit stores process content constituting the display process, by including the process content into the ending process information; and

when the operation mode selection unit has stopped keeping the operation mode selected, the display process control unit executes a process represented by the ending process information related to the operation mode having been kept selected.

(Supplementary Note 6)

The information processing device described in supplementary note 3, wherein:

the starting process information storage unit stores the content of a sending process which sends information representing the preliminary process included in the starting process information to the another information processing device, by further including the content into the starting process information; and

when the operation mode selection unit has started keeping the operation mode selected, the display process information sending unit further executes the sending process included in the starting process information related to the selected operation mode.

(Supplementary Note 7)

The information processing device described in supplementary note 4, wherein:

the during-operation-mode process information storage unit stores the content of a sending process which sends the process content included in the during-operation-mode process information to the another information processing device, by further including the content into the during-operation-mode process information; and

every time the display process is discriminated by the display process discrimination unit while the operation mode is kept selected by the operation mode selection unit, the display process information sending unit executes the sending process included in the during-operation-mode process information related to the selected operation mode.

(Supplementary Note 8)

The information processing device described in supplementary note 5, wherein:

the ending process information storage unit stores the content of a sending process of sending which sends the content included in the ending process information to the another information processing device, by further including the content into the ending process information; and

when the operation mode selection unit has stopped keeping the operation mode selected, the display process information sending unit executes the sending process included in the ending process information related to the operation mode having been kept selected.

(Supplementary Note 9)

An information processing method comprising:

detecting contacting operation to display screen and a contact position of the operation;

keeping selecting, while the contact position is kept included in any one of one or more operation areas defined in advance within the area of the display screen, a predetermined operation mode related to the operation area;

detecting information representing a motion of the own device while the operation mode is kept selected;

discriminating a content of a display process designated with respect to screen data displayed on the display screen, on the basis a combination of the operation mode and the information representing a motion of the own device; and

executing discriminated the display process on the screen data.

(Supplementary Note 10)

A computer program causing an information processing device to execute:

a process of detecting contacting operation to display screen and a contact position of the operation;

a process of keeping selecting, while the contact position is kept included in any one of one or more operation area defined in advance within the area of the display screen, a predetermined operation mode related to the operation area;

a process of detecting information representing a motion of the own device while the operation mode is kept selected;

a process of discriminating a content of a display process designated with respect to screen data displayed on the display screen, on the basis a combination of the operation mode and the information representing a motion of the own device; and

a process of executing discriminated the display process on the screen data.

(Supplementary Note 11)

The information processing device described in any one of supplementary notes 1 to 8, wherein:

the motion detection unit detects information representing a tilt of the own device; and

the display process discrimination unit discriminates the content of a display process designated with respect to the screen data, on the basis of a combination of the operation mode and the information representing a tilt of the own device.

(Supplementary Note 12)

The information processing device described in any one of supplementary notes 1 to 8 and 11, wherein:

the motion detection unit detects information representing a movement of the own device; and

the display process discrimination unit discriminates the content of a display process designated with respect to the screen data, on the basis of a combination of the operation mode and the information representing a movement of the own device.

(Supplementary Note 13)

The information processing method described in supplementary note 9 further comprising:

sending display process information representing content of the display process to be executed to another information processing device which displays screen data approximately the same as the screen data;

receiving the display process information from the another information processing device; and

executing a process represented by received the display process information on the screen data.

(Supplementary Note 14)

The computer program described in supplementary note 10 which causes the information processing device to further execute:

a process of sending display process information representing content of the display process to be executed to another information processing device which displays screen data approximately the same as the screen data;

a process of receiving the display process information from the another information processing device; and

a process of executing a process represented by received the display process information on the screen data.

### REFERENCE SIGNS LIST

1, 2, 3 information processing device
11, 21 display unit
12 contact detection unit
13 motion detection unit
14, 24 operation mode selection unit
15, 25 display process discrimination unit
16, 26, 36 display process control unit
27, 37 starting process information storage unit
28, 38 during-operation-mode process information storage unit
29, 39 ending process information storage unit
301 display process information sending unit
302 display process information receiving unit
900 computer
910 CPU
920 RAM
930 ROM
940 storage medium
950 communication interface

1: An information processing device comprising:
a display unit provided with a display screen for displaying data;
a contact detection unit which detects a contacting operation to said display screen and contact position of the operation;
a motion detection unit which detects information representing a motion of its own device (the information processing device it belongs to);
an operation mode selection unit which, while said contact position detected by said contact detection unit is kept included in any one of one or more operation areas defined in advance within the area of said display screen, keeps selecting a predetermined operation mode related to the operation area;
a display process discrimination unit which discriminates a content of a display process designated with respect to screen data displayed on said display screen, on the basis of a combination of said operation mode and said information representing a motion of the own device; and
a display process control unit which executes the display process discriminated by said display process discrimination unit on said screen data if said information representing a motion of the own device is detected by said motion detection unit while said operation mode is kept selected by said operation mode selection unit.

2: The information processing device according to claim 1, wherein:
said information processing device is connected to another information processing device displaying approximately the same screen data as said screen data, and further comprising:
a display process information sending unit which sends display process information representing the content of a display process executed by said display process control unit to said another information processing device, and
a display process information receiving unit which receives said display process information from said another information processing devices; and
said display process control unit further executes a process represented by the display process information received by said display process information receiving unit on said screen data.

3: The information processing device according to claims 1 further comprising
a starting process information storage unit which stores said operation mode and starting process information representing a process determined in advance to be executed when selection of the operation mode is started, in a manner to relate them to each other, wherein:
said starting process information storage unit stores a content of a preliminary process necessary for executing said display process, by including the content into said starting process information; and
when said operation mode selection unit has started keeping said operation mode selected, said display process control unit executes a process represented by said starting process information related to the selected operation mode.

4: The information processing device according to any one of claims 1 further comprising
a during-operation-mode process information storage unit which stores said operation mode and during-operation-mode process information representing a process determined in advance to be executed every time said display process is discriminated by said display process discrimination unit while the operation mode is kept selected, in a manner to relate them to each other, wherein:
said during-operation-mode process information storage unit stores process content constituting said display process, by including the process content into said during-operation-mode process information; and
every time said display process is discriminated by said display process discrimination unit while said operation mode is kept selected by said operation mode selection unit, said display process control unit executes a process represented by said during-operation-mode process information related to the selected operation mode.

5: The information processing device according to any one of claims 1 further comprising
an ending process information storage unit which stores said operation mode and ending process information representing a process determined in advance to be executed when selection of the operation mode has been stopped, in a manner to relate them to each other, wherein:
said ending process information storage unit stores process content constituting said display process, by including the process content into said ending process information; and
when said operation mode selection unit has stopped keeping said operation mode selected, said display process control unit executes a process represented by said ending process information related to the operation mode having been kept selected.

6: The information processing device according to claim 3, wherein:
said starting process information storage unit stores the content of a sending process which sends information representing said preliminary process included in said starting process information to said another information processing device, by further including the content into the starting process information; and
when said operation mode selection unit has started keeping said operation mode selected, said display process information sending unit further executes said sending process included in said starting process information related to the selected operation mode.

7: The information processing device according to claim 4, wherein:
said during-operation-mode process information storage unit stores the content of a sending process which sends said process content included in said during-operation-mode process information to said another information processing device, by further including the content into the during-operation-mode process information; and
every time said display process is discriminated by said display process discrimination unit while said operation mode is kept selected by said operation mode selection unit, said display process information sending unit executes said sending process included in said during-operation-mode process information related to the selected operation mode.

8: The information processing device according to claim 5, wherein:
said ending process information storage unit stores the content of a sending process which sends said process content included in said ending process information to said another information processing device, by further including the content into the ending process information; and
when said operation mode selection unit has stopped keeping said operation mode selected, said display process information sending unit executes said sending process included in said ending process information related to the operation mode having been kept selected.

9: An information processing method comprising:
detecting contacting operation to display screen and a contact position of the operation;
keeping selecting, while said contact position is kept included in any one of one or more operation areas defined in advance within the area of said display screen, a predetermined operation mode related to the operation area;
detecting information representing a motion of the own device while said operation mode is kept selected;
discriminating a content of a display process designated with respect to screen data displayed on said display screen, on the basis a combination of said operation mode and said information representing a motion of the own device; and
executing discriminated said display process on said screen data.

10: A computer program for causing an information processing device to execute:
a process of detecting contacting operation to display screen and a contact position of the operation;
a process of keeping selecting, while said contact position is kept included in any one of one or more operation area defined in advance within the area of said display screen, a predetermined operation mode related to the operation area;
a process of detecting information representing a motion of the own device while said operation mode is kept selected;
a process of discriminating a content of a display process designated with respect to screen data displayed on said display screen, on the basis a combination of said operation mode and said information representing a motion of the own device; and
a process of executing discriminated said display process on said screen data.
